(19) United States
(12) Patent Application Publication
(10) Pub. No.: US 2009/0145843 A1
(43) Pub. Date: Jun. 11, 2009

(54) Method for reducing carbon dioxide emissions and water contamination potential while increasing product yields from carbon gasification and energy production processes

(76) Inventor: Paul F. Ahner, (US)

Correspondence Address: Paul F. Ahner, 5825 E 99th ST, Tulsa, OK, 74137-5502, US

(21) Appl. No.: 12/217,233

(22) Filed: Jul. 3, 2008

Related U.S. Application Data
(60) Provisional application No. 61/005,634, filed on Dec. 5, 2007.

(51) Int. Cl. B01D 53/62; C01B 3/24; C02F 1/68; C02F 3/00

(52) U.S. Cl. 210/603; 423/220; 252/373; 210/749

(57) ABSTRACT

Carbon dioxide from a process which oxidizes a carbon containing feed is separated and reduced to carbon monoxide using a carbon dioxide reduction reactor [22, 26] coupled to a water gas shift reactor [14], to simultaneously reduce carbon dioxide emissions and increase the product yield of clean fuels. In the preferred underground carbon gasification application, these reduction and shift reactions are substantially promoted by utilizing temporary [24] and permanent storage [28] of the carbon dioxide and carbon monoxide coupled with cyclic operational procedures. Additional advantages include carbon dioxide sequestration, removal of contaminants from the groundwater affected by the process and the ability to influence groundwater flow patterns to improve gasification efficiency and reduce potential environmental effects.

This application claims priority to Provisional Patent No. 61/005,634 filed on Dec. 5, 2007

### BACKGROUND

1. Field of the Invention

This invention describes an improved method for reducing the carbon dioxide emissions and improving product yields from processes which use fossil fuels to generate energy and/or processes which produce low carbon dioxide emission fuel gas, hydrogen fuel, and liquid fuels or fertilizers using synthesis gas as the feedstock. Furthermore, in the underground application of this invention, it will improve process efficiencies, remove certain contaminants from the underground process waters and help control the flow patterns of the groundwater affected by the gasification process. Recent concern in global warming due to greenhouse gas emissions has attracted much attention to reducing the amount of carbon dioxide emitted by man. To date, the principal proposed method of reducing carbon dioxide emissions from a process was to separate it from the process off gases and inject it for storage into underground formations or use it for carbon dioxide flooding of oil reservoirs. While using carbon dioxide for enhanced oil field production is a good use for this gas, this market will quickly saturate and the market value of carbon dioxide will quickly deteriorate to nothing. At this point, carbon dioxide sequestration will become an even greater economic burden.

This invention uses carbon dioxide as a feedstock to upgrade it to a useful product and reduce carbon dioxide formation at its source to reduce the amount that must be sequestered. This invention proposes to convert the carbon dioxide to carbon monoxide which is a valuable synthesis gas feedstock for producing liquid fuels and fertilizer. This conversion is accomplished by the reverse Boudard reaction, which involves contacting the carbon dioxide with carbon (such as coal, heavy oil and bitumen) at high temperatures.

This invention can be applied to, but is not limited to the following processes; underground coal gasification, above ground coal gasification, natural gas to liquid fuels processes, biomass to synthesis gas processes, fertilizer production and processes which combust fossil fuels for energy and electrical power generation.

2. Description of Prior Art

Carbon dioxide was considered a harmless byproduct of combustion for centuries and, until recently; no attempts were made to limit carbon dioxide emissions. As such, there has been little driving force to develop the technology to reduce carbon dioxide emissions. Little prior art regarding reducing carbon dioxide at its source has been found. The current emphasis is being placed on: 1) sequestering the carbon dioxide in underground formations; 2) using it to enhance oil field production and 3) converting it to biomass. This invention promises to decrease carbon dioxide emissions in a synthesis gas to liquid fuel process and other said processes by converting the by-product carbon dioxide to carbon monoxide via contact with hot carbon. This patent is applicable to synthesis gas production processes, which use coal, oil, natural gas, biomass, tar sands or bitumen as the feedstock and is particularly applicable to Underground Coal Gasification.

Patent Application 2005/0095183, “Process and Apparatus for Biomass Gasification” May 5, 2005, by inventors A. G. Rehmat and R. L. Kao the entire disclosure of which is hereby incorporated by reference herein, describes a process which concentrates heavily on the reactor design rather than the overall process. This patent:
uses biomass and waste oil as feed for synthesis gas production and does not refer to coal or oil shale as a feedstock;
utilizes a kiln with a special gas distribution system and does not utilize a separate reactor to more efficiently reduce the carbon dioxide to carbon monoxide;
does not claim a separate carbon dioxide reduction reactor.does not claim a separate water-gas shift reactor;
claims a concurrent gas/solid flow system;
is limited to surface gasifiers;
does not employ short term carbon dioxide storage or other operational procedures to improve the carbon dioxide reduction potential of the process;
does not employ short term gas storage or other operational procedures to improve the water-gas shift performance of the process;
does not address the sequestration of the waste carbon dioxide or other substances;
does not address the overall flow schemes to maximize the production of synthesis gas, low carbon dioxide emission fuel gas or hydrogen while increasing carbon utilization;
does not address any aspects of underground carbon gasification.

U.S. Pat. No. 5,937,652, “Process for Coal or Biomass Fuel Gasification by Carbon Dioxide Extracted from a Boiler Flue Gas Stream” Aug. 17, 1999, by inventor F. T. Abdelmalek the entire disclosure of which is hereby incorporated by reference herein, describes a process in which hot coal particles are contacted with steam and carbon dioxide in a single, high temperature reactor to simultaneously promote the steam char and the carbon dioxide reduction reactions. The carbon dioxide is obtained by separating it from the boiler flue gases. The hydrogen and carbon monoxide produced from the steam char reaction is claimed to increase the carbon efficiency of the process by 20%, thereby decreasing carbon dioxide emissions. This hydrogen and carbon monoxide fuel is then burned to generate heat and carbon dioxide. Since the reactants (coal, carbon dioxide and steam) still form the same products (carbon dioxide and steam) this patent violates the second law of thermodynamics by claiming that its' more circuitous path is more energy efficient than simply burning coal. This patent:
deals only with a surface industrial coal fired boiler;
does not claim a separate carbon dioxide reduction reactor or a separate water-gas shift reactor;
does not employ short term carbon dioxide storage or other operational procedures to improve the carbon dioxide reduction potential of the process;
does not employ short term gas storage or other operational procedures to improve the water-gas shift performance of the process;
does not address the sequestration of the waste carbon dioxide or other substances;
does not address the overall flow schemes to maximize the production of synthesis gas while increasing carbon utilization;
does not address any aspects of underground carbon gasification;
does not address the production of synthesis gas or hydrogen fuel.

Objects and Advantages

Accordingly, several objects and advantages of my process are:
a) To provide a more economical method of increasing carbon dioxide utilization by incorporating a separate carbon dioxide reduction reactor to achieve greater carbon dioxide reduction;
b) to provide a method of recycling carbon dioxide back to the primary gasifier;
c) to provide a method of increasing carbon dioxide utilization by incorporating a separate water-gas shift reactor to convert the additional carbon monoxide produced from carbon dioxide reduction to hydrogen;
d) to provide a more economical means of converting a waste carbon dioxide stream to synthesis gas, a low carbon containing fuel gas and to a hydrogen fuel;
e) to provide a means of coupling fossil fuel fired energy production processes to synthesis gas production to increase carbon utilization;
f) to provide a more economical means of increasing the gasification and carbon dioxide reduction conversions by intermittently adjusting the flow rates of oxidant, carbon dioxide and pressure through the gasification and carbon dioxide reduction reactors;
g) to provide an inexpensive means of temporarily storing carbon dioxide and intermittently feeding it to underground carbon dioxide reduction reactors and the gasification reactors to increase the carbon dioxide reduction efficiency;
h) to provide an inexpensive means of temporarily storing carbon monoxide and intermittently feeding it to underground or surface water-gas shift reactors to increase the conversion efficiency and process flexibility;
i) to provide a method of controlling the amount of water influx into underground coal gasification reactors;
j) to provide a method of economically controlling the migration of underground coal gasification reactor process water;
k) to provide a method of economically removing light hydrocarbon contaminants present in the underground coal gasification reactor process water;
l) to provide a more economical means of permanently sequestering waste carbon while simultaneously groundwater flow patterns.

Further objects and advantages will become apparent from a consideration of the ensuing description and drawings.

### DRAWING FIGURES

FIG. 1 shows a plot of the fractional composition of carbon monoxide and carbon dioxide in equilibrium with beta-graphite at 1 atmosphere of pressure (14.7 psia) as a function of temperature.

FIG. 2 shows plots of the equilibrium gas compositions of the carbon steam system at 1 atmosphere (14.7 psia) and 20 atmospheres (294 psia) of pressure.

FIG. 3 shows an example of an application of this invention to surface based processes which produce a low carbon dioxide emission fuel gas, synthesis gas and/or a hydrogen fuel—specifically, the use of a carbon dioxide recycle stream through the primary gasification reactor only.

FIG. 4 shows an example of an application of this invention to surface based processes which produce a low carbon dioxide emission fuel gas, synthesis gas and/or a hydrogen fuel—specifically, the use of a designated carbon dioxide reduction reactor.

FIG. 5 shows an example of an application of this invention to underground gasification processes to produce a low carbon dioxide emission fuel gas, synthesis gas and/or a hydrogen fuel—specifically, the simultaneous spent reactor remediation, carbon dioxide storage and use of a carbon dioxide recycle stream through the primary gasification reactors only.

FIG. 6 shows an example of an application of this invention to underground gasification processes to produce a low carbon dioxide emission fuel gas, synthesis gas and/or a hydrogen fuel—specifically, the simultaneous spent reactor remediation, carbon dioxide storage and use of a carbon dioxide recycle stream using a designated carbon dioxide reduction underground reactor.

FIG. 7 shows an example of an application of this invention to processes which use carbon based fuels to generate energy and a by-product low carbon dioxide emission fuel gas, synthesis gas and/or a hydrogen fuel.

### REFERENCE NUMERALS IN DRAWINGS

10 Carbon Gasifier
12 Gas Separation Plant
14 Water-Gas Shift Reactor
16 Gas to Liquids or Fertilizer Feedstock
17 Low carbon dioxide emission fuel gas
18 Hydrogen Fuel
20 Surface Carbon Dioxide Reduction reactor(s)
22 Underground Coal Gasification Reactors
24 Spent Underground Reactors for Temporary CO2 Storage
25 Spent Underground Reactors for Temporary CO Storage
26 Underground CO2 Reduction Reactors
27 Spent Underground Reactors which need Groundwater Remediation
28 Surplus, Spent Underground Reactors for CO2 Sequestration
30 Industrial Boiler

### SUMMARY

Broadly, this invention applies to: 1) surface and underground processes which produce synthesis gas or hydrogen fuel from a carbon containing feedstock such as coal, tar sands, bitumen, biomass or natural gas, and; 2) existing fossil fueled power plants which can be modified to include synthesis gas production or hydrogen fuel production. This invention involves using the reverse Boudard reaction in combination with the water-gas shift reaction to increase the carbon utilization efficiency of the above mentioned processes, thereby decreasing carbon dioxide emissions. In addition, this invention offers options to economically reduce the environmental impact of underground gasification processes.

Overall Description and Operation

As stated above, this invention applies to: 1) processes which produce synthesis gas from a carbon containing feedstock such as coal, tar sands, bitumen, biomass or natural gas, and; 2) existing fossil fueled power plants which can be modified to include synthesis gas production as a feedstock for gas to liquid (GTL) or fertilizer production. In synthesis gas production, the carbon containing feedstock is partially combusted (gasified) using a mixture of air, oxygen, an enriched oxygen/air mixture or other oxidation agent and steam to form a mixture of carbon monoxide, hydrogen, carbon dioxide, methane and water. A typical dry product gas composition from a Lurgi type gasifier using oxygen as the oxidant can be made up of 34% carbon dioxide, 18% carbon monoxide, 36% hydrogen and 12% methane. Most of the hydrogen and carbon monoxide in the product gas is formed in the steam-char reaction (Reaction 5 below). Methane is produced from the reaction between the hot char and hydrogen but mostly from pyrolysis of the carbon bearing feedstock (Reactions 9 and 10 below). Depending on the gasification process and the type of carbon bearing fuel used, the methane concentration can range from less than 1% up to 20%.

Typically carbon gasification processes use the hydrogen, carbon monoxide and methane and just vent the carbon dioxide to atmosphere. With the advent of global warming concerns, there is pressure to reduce carbon dioxide emissions since carbon dioxide is a greenhouse gas. The most touted method of decreasing carbon dioxide is to separate it from the flue gas or from the synthesis gas and to sequester it underground or inject it into nearly spent oil fields to enhance production. This invention proposes to use the reverse Boudard reaction coupled with the water-gas shift reaction to increase the SCF of 2:1 synthesis gas produced per SCF of carbon dioxide vented/sequestered. For example, given the dry coal gasifier gas composition above, converting 50% of the separated carbon dioxide from this gas to carbon monoxide and shifting 45% of the total carbon monoxide to hydrogen will decrease the SCF of waste carbon dioxide to the to SCF of synthesis gas produced by 25.2% as compared to that attained by not practicing this patent. In this case, it also increases the SCF of raw synthesis gas per MSCF of raw dry gasifier gas from 540 SCF to 880 SCF for a 63% increase in synthesis gas yield. In the case where hydrogen is the preferred product, converting 50% of the separated carbon dioxide to carbon monoxide and shifting 75% of the total carbon monoxide to hydrogen will reduce the SCF of waste carbon dioxide vented per SCF of hydrogen produced by 45.8%. Using this invention under the same scenario increases the SCF of hydrogen per MSCF of raw dry gasifier gas from 500 SCF to 750 SCF for a 50% increase in hydrogen yield. The increased yields in both the synthesis gas case and the hydrogen case at least help to offset the cost of carbon dioxide separation and the additional costs associated with the carbon dioxide reduction reactors. The tables below illustrate the effectiveness of this invention under different operating scenarios.

TABLE 1
Carbon Efficiencies for Synthesis Gas Production (Dry, Volume Basis) vs. the Extent of CO2 Reduction and Water-Gas Shift Reactions*

| % CO2 | % CO | | SCF Raw | SCF 2:1 | | SCF Raw | SCF 2:1 | | SCF CO2 | | |
|---|---|---|---|---|---|---|---|---|---|---|---|
| from | Shifted | | Syn. | Syn. | SCF CO2 | Syn. | Syn. | % Reduction | Vented/ | SCF CO2 | SCF excess |
| Gasifier | to | | Gas/MSCF | Gas/MSCF | Vented/ | Gas/SCF | Gas/SCF | in SCF CO2 | MSCF | Vented/ | H2 prod./ |
| Reduced | H2 + | Raw | Gasifier | Gasifier | MSCF Initial | CO2 | CO2 | Vented/SCF | Raw | MSCF 2:1 | MCF Initial |
| to CO | CO2 | H2/CO | Gas | Gas | Gasifier Gas | Vented | Vented | H2 Produced | Syn. Gas | Syn. Gas | Gas |
| 0 | 0 | 2.00 | 540 | 540 | 340 | 1.59 | 1.59 | 0 | 630 | 630 | 0 |
| 20 | 30 | 2.06 | 676 | 664 | 367 | 1.84 | 1.81 | 12.2 | 543 | 553 | 12.4 |
| 50 | 45 | 2.08 | 880 | 858 | 404 | 2.18 | 2.12 | 25.2 | 459 | 471 | 22 |
| 70 | 50 | 2.09 | 1016 | 984 | 430 | 2.36 | 2.29 | 30.6 | 423 | 437 | 32 |
| 80 | 50.5 | 2.02 | 1084 | 1075 | 433 | 2.5 | 2.48 | 35.9 | 400 | 403 | 8.86 |
| 80 | 70 | 3.99 | 1084 | 575 | 574 | 1.89 | 1.13 | −40.1 | 530 | 882 | 432 |

*assuming 1 MCF of initial, cleaned, dry gas composition from the gasifier of 34% CO2, 18% CO, 36% H2, and 12% CH4.

TABLE 2
Carbon Efficiencies for H2 Production (Dry Volume Basis) assuming 75% Water-Gas Shift Conversion*

| % CO2 in Initial | | | | | % Reduction in |
|---|---|---|---|---|---|
| Gasifier Gas | % CO converted | SCF H2/MSCF Initial | % Increase in H2/SCF | SCF CO2/SCF | CO2 Vented/ |
| Converted to CO | To H2 + CO2 | Gasifier Gas | Initial Gasifier Gas | H2 Produced | H2 Produced |
| 0.00 | 75.0 | 500 | 0.00 | 0.960 | 0.00 |
| 25.0 | 75.0 | 623 | 24.6 | 0.422 | 56.0 |
| 50.0 | 75.0 | 750 | 25.4 | 0.520 | 45.8 |
| 75.0 | 75.0 | 878 | 25.6 | 0.590 | 38.5 |
| 100.0 | 75.0 | 1005 | 25.4 | 0.642 | 33.1 |

*assuming 1 MCF of initial, cleaned, dry gas composition from the gasifier of 34% CO2, 18% CO, 36% H2, and 12% CH4.

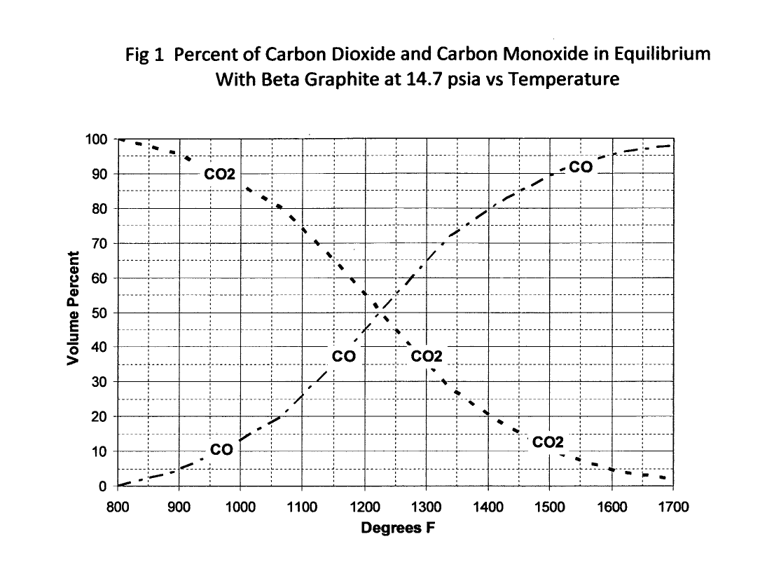

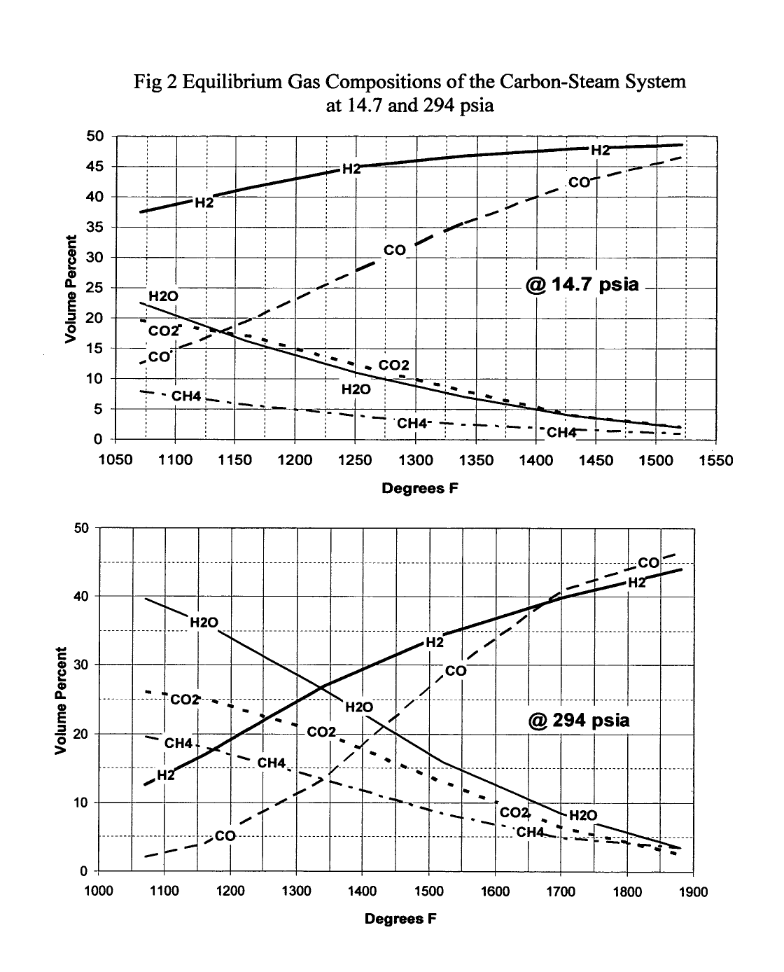

The reverse Boudard reaction is achieved by contacting the carbon dioxide with hot carbon in the 1000-2300° F. range. The equilibrium gas composition vs temperature and pressure is shown in FIG. 2. The carbon dioxide that is not reduced the first time through can be separated again and recycled back to the reactor for further reduction if desired. The water-gas shift reaction is well known and accomplished through conventional processes by those skilled in the art. The excess carbon dioxide is: 1) vented; 2) sequestered in underground formations; 3) sold for enhance oil recovery purposes; 4) sequestered in spent underground coal gasification reactors, or; 5) possibly converted to biomass. In any case, this invention promises to dramatically reduce the amount of carbon dioxide that has to be dealt with. FIGS. 1 and 2 and the gasification reactions herein provide the evidence that this invention can accomplish carbon dioxide reduction. This invention is particularly suited for use in UCG since the large size and the inherent high temperatures of the UCG reactors provide the needed residence time to allow the reactants to come closer to equilibrium.

A summary of the carbon gasification reactions follows. In this invention “carbon” refers to any carbon bearing substance such as, but not limited to, all ranks of coal, biomass, oil, oil shale, heavy oil, tar sands, bitumen, natural gas and residual oil.

Reaction Chemistry

Primary Oxidation Reactions

C+O2→CO2+94.05 kcal/g-mol (1)

C+½O2→CO+26.42 kcal/g-mol (2)

CO+½O2→CO2+67.63 kcal/g-mol (3)

C+O2→CO2+94.05 kcal/g-mol (4)

Steam—Char Reaction

H₂O+C→CO+H₂−31.4kcal/g-mol (5)

CO2 Reduction Reaction (Reverse Boudard Reaction)

CO₂+C→2CO−41.2 kcal/g-mol (6)

Water Gas Shift Reaction

CO+H2O→H₂+CO₂+9.8 kcal/g-mol (7)

CO Oxidation

2CO→CO₂+C+41.2 kcal/g-mol (8)

Methane Formation

C+2H₂→CH₄+17.9 kcal/g-mol (9)

Pyrolysis

Hydrocarbon+heat→CH₄+CO+H₂+light hydrocarbons (10)

### DETAILED DESCRIPTION AND OPERATIONS—FIGS. 1-7

FIG. 1 is a plot of the equilibrium gas compositions of carbon monoxide and carbon dioxide in the presence of solid phase carbon versus temperature. This figure shows that, the reduction of carbon dioxide to carbon monoxide (Reaction 6) in the presence of elemental carbon is favored at high temperatures.

FIG. 2 is a plot of the equilibrium gas compositions of the carbon/steam system versus temperature at both 0 psig and at 294 psig. This plot reveals that the steam char reaction (Reaction 5) favors the production of carbon monoxide and hydrogen in the same temperature range as the carbon dioxide reduction reaction (Reaction 6). FIG. 2 also reveals that the desired reactions employed in this invention are favored under lower temperature and low pressure conditions. If higher pressures are employed in the process, higher temperatures are required to achieve the same degree of conversion to synthesis gas.

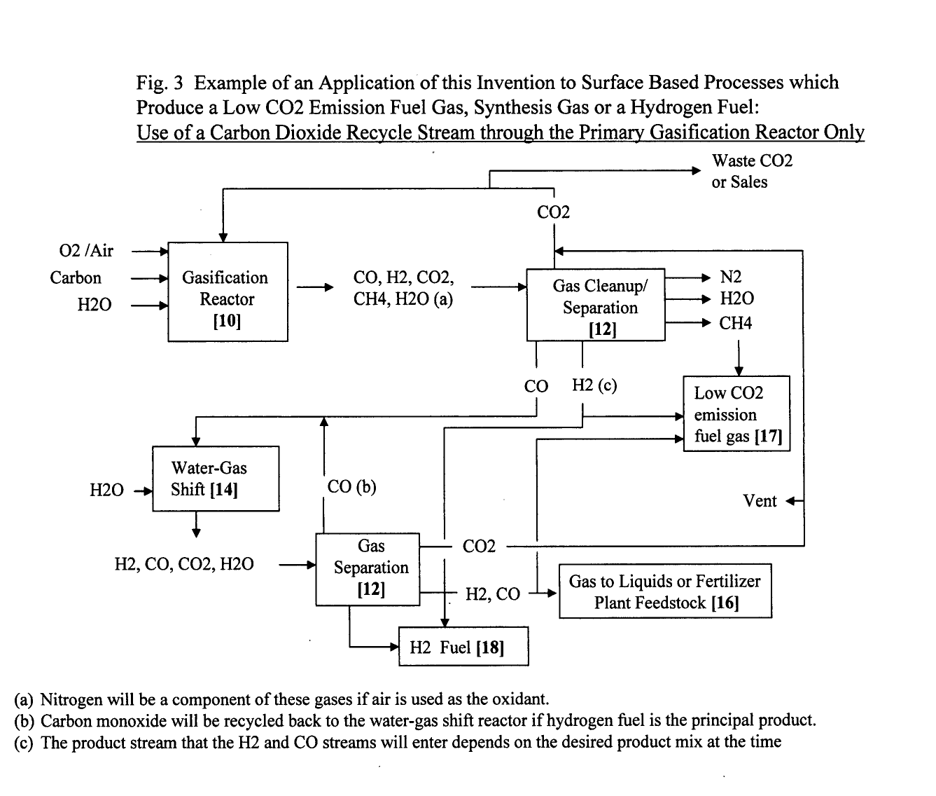

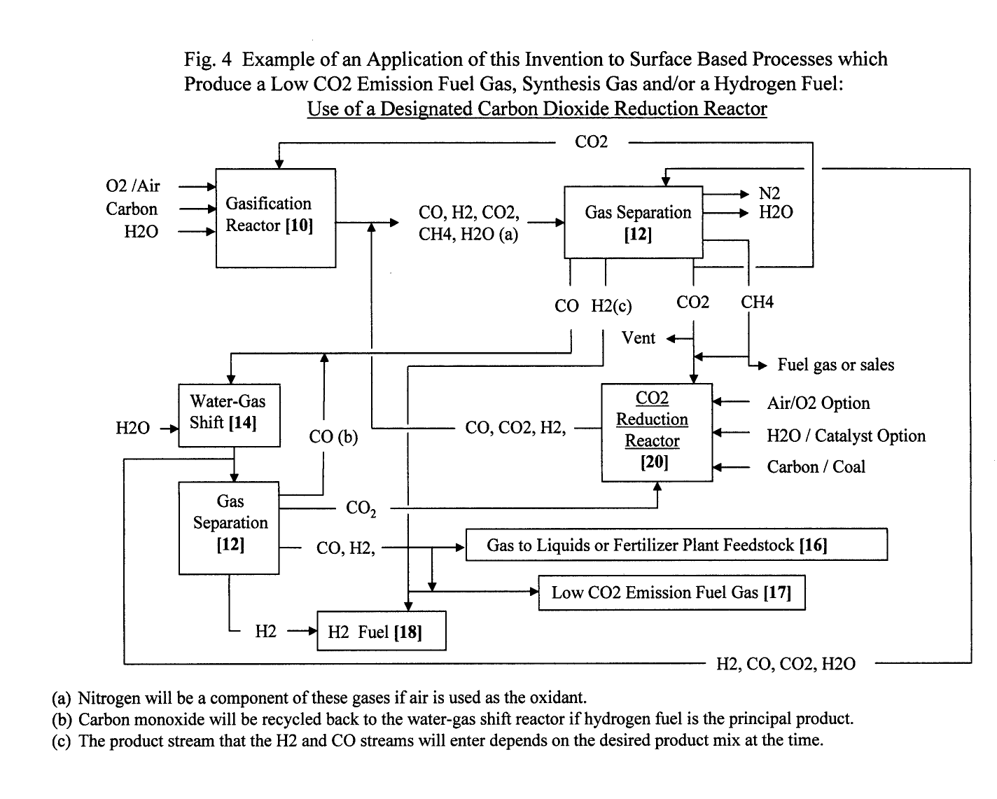

FIG. 3 illustrates the use of this invention in a surface carbon gasification plant where the carbon dioxide from the gas separation plant [12] is recycled back to the primary carbon gasification reactor [10] to reduce a fraction of the separated carbon dioxide to carbon monoxide via Reaction 6. The water-gas shift reactor [14] is then used to adjust the hydrogen to carbon monoxide ratio via Reaction 7 to the appropriate ratio. (around 2:1) for synthesis gas production. If hydrogen fuel is the preferred product, the carbon dioxide from the water gas shift product is recycled back to the gasifier [10] to produce additional carbon monoxide which is then shifted to additional hydrogen [18]. Using the equilibrium plots shown in FIGS. 1 and 2 along with kinetic data, this surface gasification reactor would be designed to have a temperature distribution and be of sufficient size to promote the carbon dioxide reduction (Reaction 6) as well as the steam char reaction (Reaction 5). This figure, as well as FIGS. 4 through 7, illustrates three possible end uses of the products from this process: 1) low carbon dioxide emission fuel gas [17]; 2) synthesis gas [16]; and, 3) hydrogen fuel [18]. In all likelihood, at least two of these three products would be produced by any plant which uses this invention. Excess carbon dioxide is sold, converted, sequestered or vented. Although FIGS. 3 through 7 show multiple gas separation plants, those skilled in the art would most likely design the process using one gas separation plant.

FIG. 4 illustrates the use of this invention in a surface carbon gasification plant where the carbon dioxide is sent to reduction reactors [20] which are specifically designed and operated to reduce the carbon dioxide to carbon monoxide at higher conversions (Reaction 6) than can be obtained by only using the gasification reactor [10] to reduce the carbon dioxide. The reverse boudard carbon dioxide reduction reactor [20] could utilize pulverized coal injection as the carbon source or any other carbon bearing substance. If desired, the carbon dioxide stream from the gas separation plant [12] could be split between the carbon dioxide reduction reactor [20] and the primary gasification reactors [10]. An oxygen containing gas could be injected into (or ahead of) the carbon dioxide reduction reactor [20] along with the separated methane and burned to provide the temperatures required for carbon dioxide reduction. As in FIG. 3, the operations around the reactors would be adjusted by those skilled in the art to produce: 1) low carbon dioxide emission fuel gas [17]; 2) synthesis gas [16]; or, 3) hydrogen fuel [18].

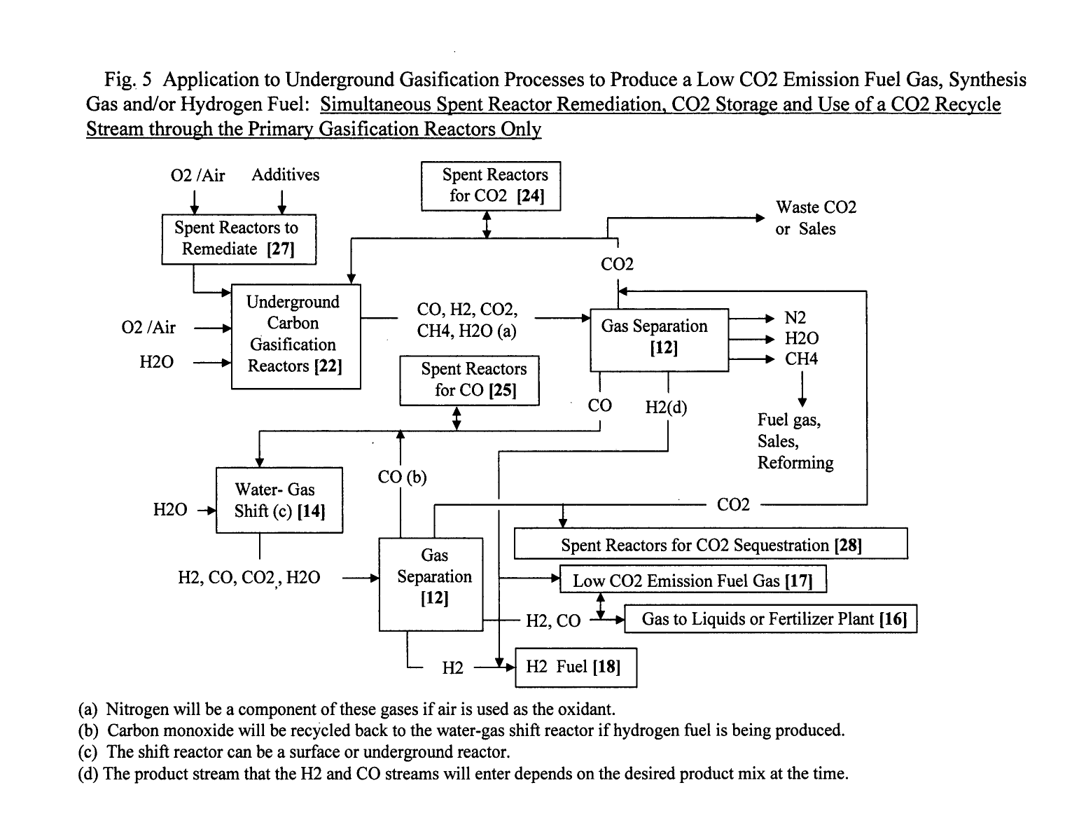

FIG. 5 illustrates the use of this invention in an underground coal gasification (UCG) process that sends the carbon dioxide from the gas separation plant [12] to the underground coal gasification reactor [20] for carbon dioxide reduction. As in the former configurations, the operations around the reactors would be adjusted by those skilled in the art to produce the desired products. A short description of UCG is warranted to explain this configuration. UCG is accomplished by the following steps: 1) drilling a widely spaced pair of process wells consisting of an injection well and a product well, completed in the coal seam; 2) establishing gas flow communication between the wells by directional drilling, reverse burn linking or other means; 3) igniting the coal at the base of the injection well; and co-injecting oxidant and steam to support combustion and the carbon gasification reactions described above. The typical composition of the gases arriving at the production well is very similar to the Lurgi surface gasifier gases described above. This area between the injection and product wells is referred to as a UCG “reactor” [22]. This operation continues until the most of the coal between these process wells is gasified. At that point, the UCG reactor is shut in and new wells are drilled to repeat the operation. The “spent” UCG reactors [24] are basically large, gas tight subterranean voids which contain some contaminated groundwater. This invention offers the opportunity to both remove some of the contamination from the groundwater and to improve process efficiency. The light hydrocarbons, such as benzene and ethyl benzene, can be removed from the water in the spent UCG reactors which need groundwater remediation [27] by sending the oxidant used in the process through the contaminated spent reactors prior to injection into the active gasifiers. Field studies have shown that gas stripping of contaminated UCG cavity water removes light hydrocarbons to low, parts per billion levels. The oxidant will also encourage the growth of organisms which will help to degrade other contaminants in the groundwater. These reactors could be inoculated with the appropriate organisms by those skilled in the art to speed the bioremediation process. In addition to the environmental benefit, these “spent” UCG reactors [24] offer a unique opportunity to temporarily store the separated carbon dioxide from the process gases to later send to the carbon dioxide reduction reactor which, in this case, consists of the primary UCG gasifiers. Other spent reactors can be used to store carbon monoxide for the water-gas shift reactor [14]. It can be recognized by those skilled in the art that using stored carbon dioxide offers the flexibility to adjust the carbon dioxide feed concentration to the primary gasification reactors to help drive the reduction further to completion than could be attained without storage. Similar benefits may be attained by temporarily storing carbon monoxide for the water-gas shift reactor and intermittently feeding it. This storage ability also allows greater operational and design flexibility in the other sections of the plant since flow fluctuations in the other operating sections of the plant can be temporarily absorbed by the using the storage capability of the spent reactors.

A typical, but not all inclusive, example operation using these spent reactors and the primary gasification reactor(s) is described in the following steps: 1) sending all or part of the oxidant used for gasification through contaminated spent UCG reactors [27] prior to injection into the active gasifiers, 2) inoculating the contaminated spent reactors with the appropriate organisms to enhance the bioremediation process; 3) storing carbon dioxide in the spent reactors [24] until they are filled to a predetermined amount; 4) sending the stored carbon dioxide with or without co-injection of the steam and oxidant to the primary gasifiers [22] to maximize carbon dioxide reduction; 5) switching back to the carbon dioxide storage mode while the primary gasifiers regain the proper temperature to sustain another phase of carbon dioxide injection; 6) adjusting the hydrogen/carbon monoxide ratio in the surface or underground water-gas shift reactors; 7) permanently sequestering the waste carbon dioxide in surplus, spent reactors [28] using the existing process wells and process piping; and, 8) switching the oxidant flow and inoculant addition to another contaminated spent reactor after the on stream spent reactor has been remediated to a predetermined extent.

Choosing the appropriate reactors to keep pressurized with waste carbon dioxide (step 7 above) or other waste gas will: 1) create a pressure barrier to control groundwater influx into the active gasification area; and, 2) provide some control over contaminated UCG process water migration. For example, the pressure barrier afforded by pressuring the reactors on the periphery of the main gasification area would help discourage excessive groundwater influx into the main gasification area thereby increasing gasification efficiency. A similar pressurization rationale would be used to alter groundwater flow patterns to help alleviate the possible spread of contaminants into areas not directly affected by the UCG process.

In addition to the advantages of using spent reactors for temporary gas storage mentioned above, it can be recognized by those skilled in the art of gas stripping, that temporary gas storage offers the benefit of removing light hydrocarbons such as benzene from the waters which influx into the spent reactors. Field studies have shown that gas stripping of contaminated UCG cavity water removes light hydrocarbons to low, parts per billion levels.

In addition to the large void volume which the spent UCG reactor offers for carbon dioxide sequestration, these spent reactors also offer a much larger surface area into which the carbon dioxide can enter the formation and solubilize into the groundwater over that provided by typical deep injection storage wells. This larger surface area improves the injectivity (SCF of carbon dioxide injected/psi pressure needed) and the rate at which the spent reactor can store the carbon dioxide.

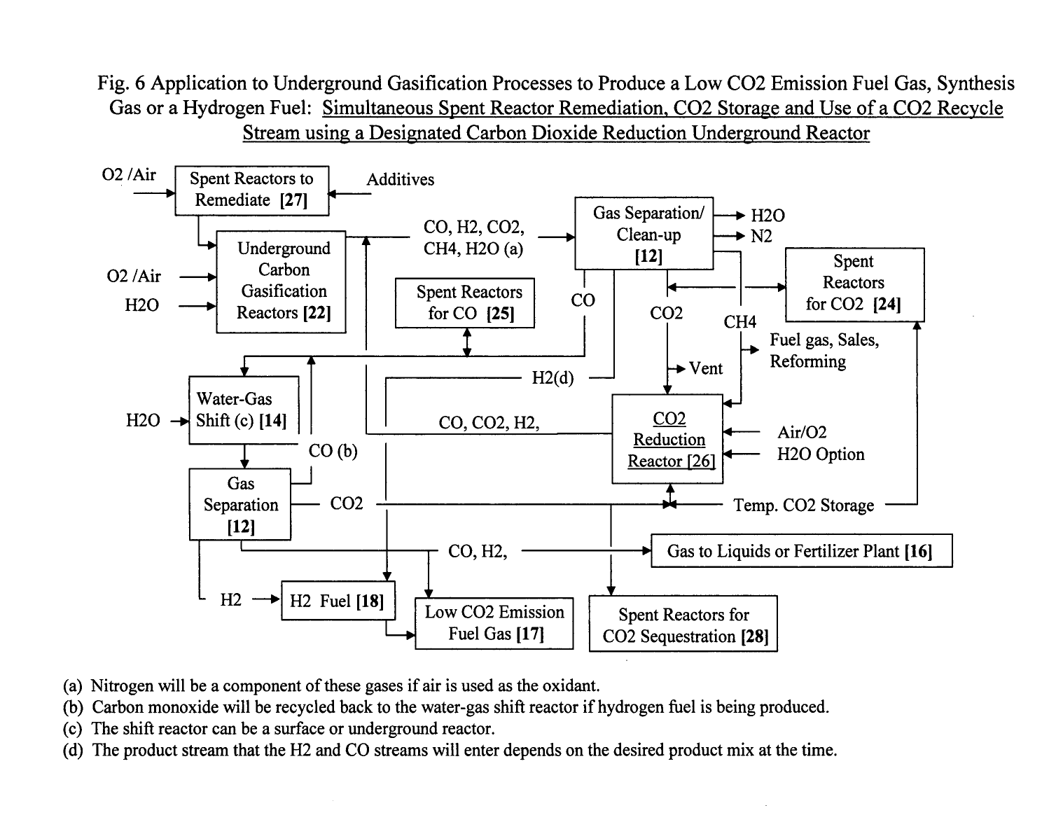

The preferred configuration in FIG. 6, in addition to claiming all of the advantages associated with the FIG. 5 configuration, offers the option to maximize the carbon dioxide reduction reactions. FIG. 6 illustrates the preferred use of this invention in an underground coal gasification process. The carbon dioxide is sent to designated underground reactors [26] which are specifically operated to reduce the carbon dioxide to carbon monoxide at higher conversions than can be attained in the gasification reactors [22] alone. These underground carbon dioxide reduction reactors [26] would preferably be designed and operated to have the following characteristics: 1) a larger well spacing between process wells to increase the reactor residence time and to maximize carbon to carbon dioxide surface area for reaction; and, 2) be run hotter on an intermittent basis to provide the heat needed to reduce the carbon dioxide more effectively. The carbon dioxide stream can be split between these carbon dioxide reduction reactors [26] and the primary underground gasification reactors [22]. As in FIG. 5, the shift reaction can be accomplished either above or below ground with the option of storing carbon monoxide feed [19] to enhance operational flexibility and the water-gas shift performance. The product options for this process, which are identical to those described before, are also shown in FIG. 6.

A typical, but not all inclusive, example operation using the spent storage reactors coupled with the carbon dioxide reduction reactors is described in the following steps: 1) sending all or part of the oxidant used for gasification through contaminated spent UCG reactors [27] prior to injection into the active gasifiers, 2) inoculating the contaminated spent reactors with the appropriate organisms to enhance the bioremediation process; 3) storing carbon dioxide in the spent reactors [24] until they are filled to a predetermined amount; 4) splitting (not necessarily equally) the stored carbon dioxide between the primary gasifier [22] and the reverse Boudard reactor [26] to maximize carbon dioxide reduction; 5) switching back to the carbon dioxide storage mode while the primary gasifiers [22] and reverse Boudard reactors [26] regain the proper temperature to sustain another phase of carbon dioxide injection. As in the former configurations, the operations around the water-gas shift reactor [14] would be adjusted to produce the low carbon dioxide emission fuel gas, a synthesis gas and/or a hydrogen fuel. 6) adjusting the hydrogen/carbon monoxide ratio in the surface or underground water-gas shift reactors; 7) permanently sequestering the waste carbon dioxide in surplus, spent reactors [28] using the existing process wells and process piping; and, 8) switching the oxidant flow and inoculant addition to another contaminated spent reactor after the on stream spent reactor has been remediated to a predetermined extent.

As in FIG. 5, the water-gas shift reactor could either be a surface or an underground reactor. Also as in FIG. 5, the surplus, spent underground reactors can be used to inexpensively sequester the waste carbon dioxide from the process using the existing wells and piping already in place. Choosing the appropriate reactors to keep pressurized with waste carbon dioxide or other gas will provide the gasification and environmental advantages discussed in FIG. 5.

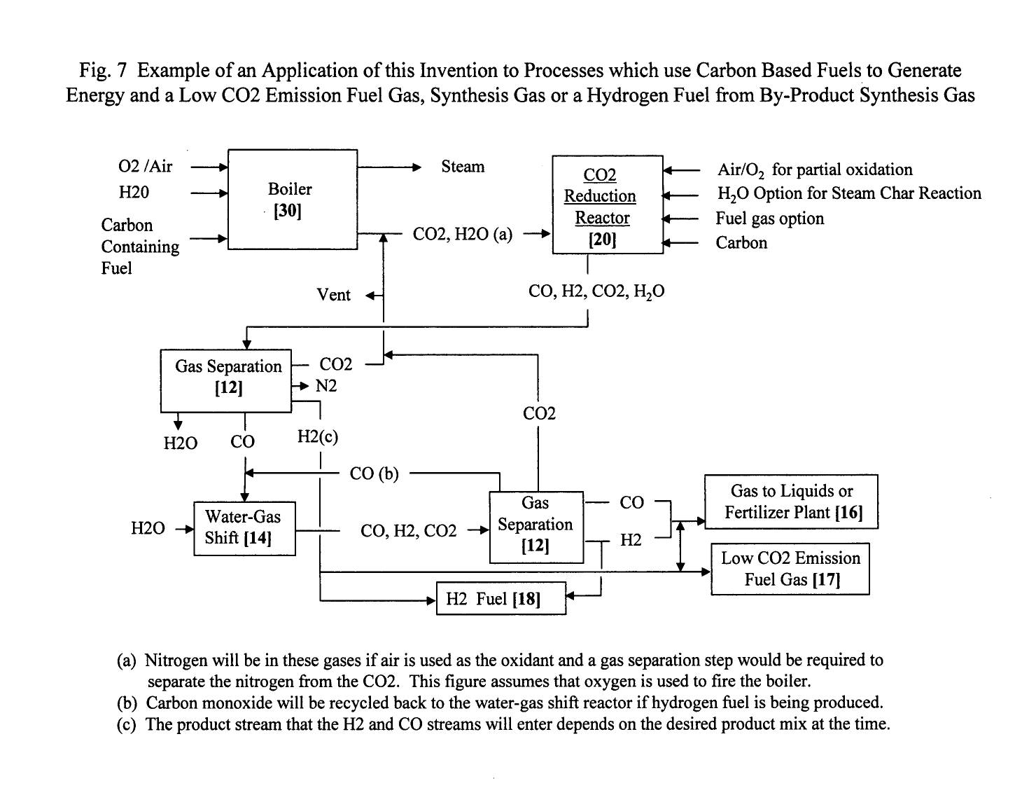

FIG. 7 illustrates the use of this invention in a boiler operation where fossil fuels are used to create energy for power generation or other uses. In the oxygen fed scenario, the carbon dioxide rich flue gas from the boiler [30] is sent to a carbon dioxide reduction reactor [20] and then sent to a gas separation plant [12]. In this particular application, the feed to the carbon dioxide reduction reactor consists of an oxidant, steam and fuel gas as well as carbon to produce a mixture of carbon monoxide, carbon dioxide, hydrogen and H2O. The low carbon dioxide emission fuel gas is used to supply the heat for the carbon dioxide reduction. The unreduced carbon dioxide from the gas separation plant is routed back to the carbon dioxide reduction reactor [20] and the carbon monoxide is sent to the water-gas shift reactor [14] for hydrogen to carbon monoxide ratio adjustment. The extent of shift would be controlled by those skilled in the art to achieve the desired product mix. The additional carbon dioxide formed in the water-gas shift reactor is separated and sent back to the carbon dioxide reduction reactor.

### SUMMARY, RAMIFICATIONS AND SCOPE

The reader will see that the reverse Boudard carbon dioxide reduction reaction coupled with the water gas shift reaction can significantly reduce the carbon dioxide emissions from any process which oxidizes a carbon bearing fuel while providing a higher yield of useful product than can be obtained without the use of the reverse Boudard reaction. It decreases the SCF of waste carbon dioxide per MSCF of product and increases the amount of synthesis gas product produced per MSCF of raw gasifier gas thereby helping to offset the cost of gas separation and carbon dioxide reduction. Products can be a low carbon dioxide emission fuel gas, synthesis gas, hydrogen or include all three.

This invention is particularly suited to underground coal (carbon) gasification since the building and construction carbon dioxide burden and cost associated with applying this invention to UCG is much less than when applied to surface gasification. In the underground application, this patent also promises to reduce the contamination potential and increase the gasification efficiency of the process.

I claim:

1. A method for reducing the carbon dioxide emissions, increasing product yield and process efficiency from any operation which oxidizes carbon. These improvements are accomplished by incorporating the carbon dioxide to carbon monoxide reduction reaction with or without the conversion of carbon monoxide to hydrogen via the water-gas shift reaction.

2. The method of claim 1 wherein the reactors used for said carbon gasification, carbon dioxide reduction to carbon monoxide and carbon monoxide conversion to hydrogen can be surface or underground reactors.

3. The method of claim 1 wherein said reduction of carbon dioxide to carbon monoxide is accomplished by contacting the carbon dioxide with hot carbon in specially designed and/or operated reactors which are operated independently of the primary gasification reactors to accomplish greater carbon dioxide reduction.

4. The method of claim 3 where the feeds to said carbon dioxide reduction reactor can consist of steam, oxidant and fuel gas in addition to carbon to promote both said carbon dioxide reduction reaction and the steam-char reaction to increase the production of the desired products.

5. The method of claim 3 wherein said carbon dioxide reduction reactor is designed and operated to provide high temperature, high carbon surface area and long residence times to substantially promote the reduction of carbon dioxide.

6. The method of claim 2 wherein the spent underground reactors are used to temporarily store the gases which are later introduced into the gasification, carbon dioxide reduction and shift reactors to promote the desired reactions by controlling feed flow rates and feed concentrations.

7. The method of claim 2 wherein the procedure for operating said reactors is modified to incorporate intermittent operation in the combustion mode, the gasification mode, the carbon dioxide reduction mode and water-gas shift mode to further optimize the yield of products and decrease carbon dioxide emissions.

8. The method of claim 1 wherein said carbon dioxide reduction reaction, with or without said water-gas shift reaction, is coupled with a fossil fueled industrial boiler or an electrical generation plant to co-produce synthesis gas, low carbon dioxide emission fuel gas and hydrogen.

9. The method of claim 1 where the final product streams can be a low carbon dioxide emission fuel gas, a synthesis gas and a hydrogen fuel.

10. The method of claim 1 which recycles the unreduced carbon dioxide back to the primary gasification reactor and/or the carbon dioxide reduction reactor to accomplish further carbon dioxide reduction.

11. A method for sequestering carbon dioxide or other wastes in spent underground carbon gasification reactors while simultaneously controlling the migration of groundwater and underground process water to improve process efficiency and control contaminant migration.

12. The method of claim 11 wherein said carbon dioxide is sequestered using the existing wells, hardware and piping associated with the underground carbon gasification process to economically sequester said carbon dioxide.

13. The method of claim 11 wherein the large cavity volumes and surface areas of said spent carbon dioxide sequestration reactors greatly improve the solubilization rate of the carbon dioxide into the groundwater thereby improving the carbon dioxide injectivity and the rate at which the carbon dioxide can be stored.

14. The method of claim 11 wherein the location of said sequestration reactors are preferably located in areas which control the flow of groundwater into the active gasification area to improve gasification efficiency.

15. The method of claim 11 wherein the pressure on said spent underground coal gasification reactors used for said carbon dioxide sequestration or other waste sequestration is adjusted to control the migration of substances across the areas influenced by the spent reactors.

16. A method to remediate the water in the still contaminated, underground coal gasification reactors.

17. The method of claim 16 wherein the oxidizing gasification agent is sent through the spent, still contaminated underground reactors prior to injection into the active underground coal gasification reactors to gas strip the light hydrocarbons from the contaminated water in the spent reactor.

18. The method of claim 17 wherein the spent, still contaminated underground reactors are inoculated with the appropriate organisms before, during and after the injection of the oxidizing gasification agent into these spent reactors to speed the bioremediation process.

19. The method of claim 16 wherein the temporary storage of carbon dioxide or other gas in said spent underground reactors strips the lighter organic contaminants such as benzene from the contaminated water present in the spent reactor.
